(19) United States
(12) Patent Application Publication
(10) Pub. No.: US 2019/0003880 A1
(43) Pub. Date: Jan. 3, 2019

(54) ELECTRO-OPTICAL TRANSDUCER

(71) Applicant: THALES, COURBEVOIE (FR)

(72) Inventors: Raphaël LARDAT, SOPHIA ANTIPOLIS (FR); François-Xavier LAUNAY, SOPHIA ANTIPOLIS (FR)

(21) Appl. No.: 16/063,194

(22) PCT Filed: Dec. 13, 2016
(86) PCT No.: PCT/EP2016/080860

§ 371 Date: Jun. 15, 2018

(30) Foreign Application Priority Data
Dec. 16, 2015 (FR) 1502606

(51) Int. Cl. G01H 9/00; G01D 5/26; G01V 1/18; G01V 1/22; G08C 23/06; H04R 1/44; H04R 23/00; H04R 17/02

(52) U.S. Cl. CPC G01H 9/004; G01D 5/268; G01V 1/186; H04R 17/02; G08C 23/06; H04R 1/44; H04R 23/008; G01V 1/226

(57) ABSTRACT

An electro-optical transducer includes a section of optical fiber including a sensitive area conveying an optical signal representative of an elongation of the sensitive area, the section of optical fiber being taut and extending longitudinally at rest substantially along a longitudinal axis, a piezoelectric actuator including at least one piezoelectric assembly including a piezoelectric bar, the piezoelectric bar extending longitudinally at rest substantially parallel to the longitudinal axis, the piezoelectric bar being provided with a pair of electrodes between which the piezoelectric bar is intended to be supplied with electric power by way of an electrical signal delivered by a sensor, the piezoelectric bar being intended to deform essentially through expansion or contraction of said bar parallel to the longitudinal axis in response to a variation in the electrical signal and being coupled mechanically to the section of optical fiber such that this expansion or contraction of the piezoelectric bar brings about a variation in elongation of the sensitive area, and the piezoelectric bar is formed of a single crystal and intended to vibrate in mode.

The general field of the invention is that of optical fiber measurement devices for measuring physical quantities and for delivering an optical signal, conveyed by an optical fiber, representative of the measured physical quantity. It relates more particularly to devices for measuring a physical quantity that comprise a physical quantity sensor with an electrical output delivering an electrical signal representative of a measured physical quantity, and a piezoelectric electro-optical transducer receiving the electrical signal and for converting, through a piezoelectric effect, the electrical signal into an elongation of a sensitive area of an optical fiber so as to vary a characteristic of an optical signal conveyed by the optical fiber depending on the variation in the electrical signal. Generally, the sensitive area of the optical fiber is an optical fiber laser. Varying the elongation of an optical fiber laser results in a variation in the frequency of an optical signal emitted by the optical fiber laser in response to a pumping energy conveyed by the optical fiber.

This invention applies most particularly to hybrid hydrophones of the type comprising an acoustic sensor, generally of piezoelectric type, for delivering an electrical signal representative of an acoustic pressure to which the sensor is subjected, and an electro-optical transducer for converting the electrical signal delivered by the sensor into an optical signal, conveyed by the optical fiber, representative of the measured acoustic pressure. It relates for example to antennae in the form of an elongate object of long length or to acoustic barriers, which are antennae placed on the seabed and that make it possible to monitor the crossing of boats, most commonly for example on the approach to important areas (ports, oil platforms, wind farms, etc.).

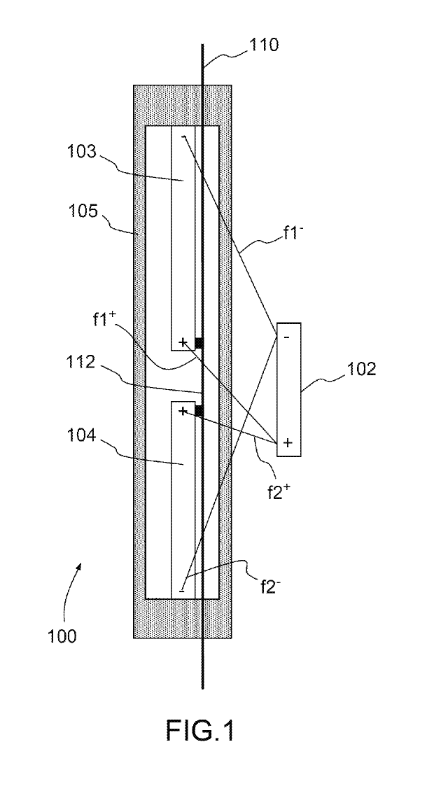

One example of an electro-optical transducer 100 with a piezoelectric actuator is described in patent application WO 2007/056827. This electro-optical transducer is shown schematically in FIG. 1. It comprises an optical fiber 110 comprising a sensitive area 112 of fiber laser type. The optical fiber conveys an optical signal representative of the elongation of the sensitive area along the axis of the fiber in response to a pumping energy conveyed by the optical fiber. The transducer 100 also comprises a piezoelectric actuator comprising two piezoelectric bars 103, 104. Each piezoelectric bar comprises two electrodes, positive +, negative −, between which the delivered electrical voltages are applied, creating an electrical field inside the bar, through an acoustic sensor 102 via electrical wires f1⁺, f1⁻, f2⁺, f2⁻. The piezoelectric bars 103, 104 are able to expand and contract freely in the direction of their lengths in response to a variation in the electrical signal. The piezoelectric bars 103, 104 are coupled mechanically to the optical fiber 110 such that the expansion or the contraction of the piezoelectric bars in the direction of their lengths brings about a variation in elongation of the sensitive area 112 of the optical fiber 110 in the longitudinal axis of the optical fiber. The assembly is integrated into a rigid housing 105.

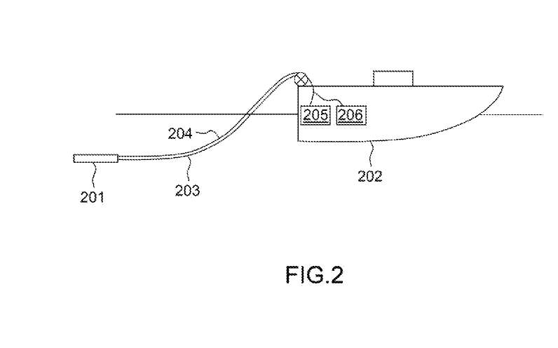

This type of hybrid hydrophone is particularly advantageous in the field of underwater acoustic antennae, which are conventionally produced in the form of an elongate object of small diameter. They are also called linear antennae or flutes. An acoustic linear antenna incorporates a plurality of hydrophones and is intended to be towed by a marine vessel or linked to a ground station by way of a traction cable of long length (possibly exceeding 1 km and reaching 10 km). An acoustic antenna of this type generally forms part of a measurement device, as shown in FIG. 2. The measurement device comprises an acoustic linear antenna 201 towed by a marine vessel 202 by way of a traction cable 203, a power supply unit 205 for producing the power intended to supply the devices contained in the antenna, and a processing unit 206 intended to process the measurements from the various sensors in order to detect and possibly locate objects. The power supply unit and the processing unit are remotely located on board the marine vessel 202 or on a ground station. A cable link 204 is provided between the acoustic antenna 210 and the processing and power supply units 205, 206. Converting the electrical signals delivered by the acoustic sensors into optical signals conveyed by an optical fiber makes it possible to ensure that the optical fiber 204 transports the information delivered by the sensors to the processing unit 206 without the addition of external electric power and without the need for electrical wires. In other words, the transducer provides a function of transporting the information from the sensors without the need for electric power. This is therefore a compact, inexpensive and lightweight solution. This solution also makes it possible to spectrally multiplex a plurality of hydrophones on one and the same optical fiber by configuring the various lasers such that they emit optical signals having different respective wavelengths. The processing unit 206 then comprises means for demultiplexing the signals from the respective hydrophones and for deducing therefrom the acoustic pressure measurements from the respective hydrophones.

It is possible to sum the measurements originating from a plurality of acoustic sensors by arranging them in parallel and/or in series and by connecting them to one and the same electro-optical transducer, thereby making it possible to reduce the number of optical fibers required to transport information. The cost of the measurement device is thus reduced. Moreover, a piezoelectric actuator requires a very low-power electric power supply to convert a variation in an electrical signal into a variation in elongation of an optical fiber. The level of electric power of an electrical signal delivered by a piezoelectric acoustic sensor subjected to a low-amplitude pressure wave (of the order of 45 dB μPa) is enough to make the actuator operate. Thus, the addition of electric power from another electric power source is not necessary. The acoustic sensors operate as voltage sources proportional to the pressure to be measured, and this voltage source is read and converted into an elongation of the optical fiber, all without the addition of any electric power source. In other words, the transducer provides a function of reading the measurements from the sensors without the need for electric power. Moreover, amplifying and digitizing the output signals from the sensors, which would require an addition of external power, is not necessary.

In the solution shown in FIG. 1, the electromechanical coupling of each piezoelectric bar is longitudinal. In other words, each piezoelectric bar is intended to vibrate in a longitudinal vibrational mode, also called mode 33. The capacitance of the transducer as a low-frequency approximation is given by the following formula:

$${C}_{aa} = 2 {n}^{2} \frac{A}{L} {ɛ}_{33}^{T} \qquad [ 1 ]$$

where n is the number of sections connected in parallel across each piezoelectric bar, where L is the length of the piezoelectric bars, ε₃₃^{T} is the dielectric coefficient and A is the area of the piezoelectric bars in a plane perpendicular to their length. The capacitance of the transducer is expressed in farads.

In order to increase the electro-optical sensitivity of the hydrophones, that is to say the variation in frequency of the laser depending on the variation in the acoustic pressure (expressed in Hz/Pa), the capacitance of the transponder should be close to that of the sensor (for example hydrophone) to which it is electrically linked. To this end, it is necessary, for a predetermined length L, to increase the number n of sections connected in parallel along a piezoelectric bar. This involves dividing each bar into a plurality of sections that are linked to the sensor by way of a pair of electrical wires and a dedicated pair of electrodes. However, this solution has a certain number of drawbacks. Multiplying the number of electrical wires and of electrodes leads to a loss in terms of simplicity of the architecture and of manufacturing.

One aim of the invention is to mitigate at least one of the abovementioned drawbacks.

To this end, one of the invention is an electro-optical transducer for converting an electrical signal delivered by a physical measurement sensor into an optical signal, said electro-optical transducer comprising:

an optical fiber comprising a section of optical fiber comprising a sensitive area, the optical fiber conveying said optical signal, said optical signal being representative of an elongation of the sensitive area, the section of optical fiber being taut and extending longitudinally at rest substantially along a longitudinal axis,

a piezoelectric actuator comprising at least one piezoelectric assembly comprising a piezoelectric bar, the piezoelectric bar extending longitudinally at rest substantially parallel to the longitudinal axis, said piezoelectric bar being provided with a pair of electrodes between which the piezoelectric bar is intended to be supplied with electric power by way of the electrical signal, said piezoelectric bar being intended to deform essentially through expansion or contraction of said bar parallel to the longitudinal axis in response to a variation in the electrical signal and being coupled mechanically to the section of optical fiber such that this expansion or contraction of the piezoelectric bar brings about a variation in elongation of the sensitive area,

the piezoelectric bar is formed of a single crystal and is intended to vibrate in mode 31 or 32.

The transducer advantageously has at least one of the following features, taken alone or in combination:

the transducer comprises a housing enclosing said actuator, said section of optical fiber, the piezoelectric bar comprising a mobile end able to move with respect to the housing upon said expansion or said contraction of the piezoelectric bar substantially parallel to the longitudinal direction,

the piezoelectric actuator comprises a coupling device for mechanically coupling the mobile end to the section of optical fiber, said coupling device comprising a carriage fixed to a portion of the section of optical fiber and being able to move in translation with respect to the housing along the longitudinal axis, said coupling device furthermore comprising a linking unit for linking the carriage to a joining area attached to the housing, the linking unit being designed to permit a translation of the carriage with respect to the housing in the axial direction but to prevent any significant movement of the carriage with respect to the housing in a plane perpendicular to the axial direction;

the piezoelectric bar comprises what is termed a fixed end, which is fixed with respect to the housing;

the linking unit comprises at least one flexion strip extending, at rest, in a plane substantially perpendicular to the longitudinal axis and linking the carriage to a joining area attached to the housing;

the strip is rotationally symmetrical about the axis,

the transducer comprises two strips extending, at rest, in different respective planes that are substantially perpendicular to the longitudinal axis,

the transducer comprises a housing enclosing the piezoelectric actuator and the section of optical fiber, said piezoelectric actuator comprises a plurality of piezoelectric assemblies arranged so as to form at least one pair, called longitudinal pair, of two piezoelectric assemblies whose piezoelectric bars each comprise an end that is fixed with respect to the housing and a mobile end able to move with respect to the housing under the effect of an expansion or of a contraction of said piezoelectric bar, said piezoelectric bars of the two piezoelectric assemblies of the longitudinal pair being aligned along an axis substantially parallel to the longitudinal axis and their mobile ends moving in opposite directions under the effect of an expansion of said bars or under the effect of a contraction of said piezoelectric bars parallel to the longitudinal axis, the portions of the section of fiber that are attached to the mobile ends of said piezoelectric bars surrounding the sensitive area,

the fixed ends of the piezoelectric bars of the two piezoelectric assemblies of the longitudinal pair are positioned facing one another;

the piezoelectric actuator has a first plane of symmetry perpendicular to the axis,

the transducer comprises a housing enclosing the piezoelectric actuator and the section of optical fiber, said piezoelectric actuator comprises a plurality of piezoelectric assemblies arranged so as to form at least one group, called transverse group, of a plurality of piezoelectric assemblies whose piezoelectric bars each comprise an end that is fixed with respect to the housing and a mobile end able to move with respect to the housing under the effect of an expansion or of a contraction of said piezoelectric bar substantially parallel to the longitudinal axis, said piezoelectric bars of the piezoelectric assemblies comprising at least one transverse pair of piezoelectric assemblies whose piezoelectric bars are situated respectively on either side of the longitudinal axis in a direction perpendicular to the longitudinal axis, being attached to one and the same portion of the section of optical fiber and moving in the same direction under the effect of an expansion of said piezoelectric bars or under the effect of a contraction of said piezoelectric bars parallel to the longitudinal axis,

the transducer comprises four piezoelectric assemblies forming two longitudinal pairs and two transverse groups, each transverse group each comprising a transverse pair,

the piezoelectric actuator has two planes of symmetry that are perpendicular to one another and contain the axis,

the carriage and/or the joining area and/or the housing are made from a material having a coefficient of thermal expansion of less than 10.10⁻⁶/K⁻¹ at 15° C. and at atmospheric pressure.

The invention also relates to a device for measuring a physical quantity comprising an electro-acoustic transducer as claimed in any one of the preceding claims, a sensor able to deliver the electrical signal, the electrical signal being representative of a physical quantity measured by said sensor, said sensor being coupled electrically to said bar so as to supply said piezoelectric bar with electric power by way of the electrical signal.

Advantageously, the device comprises a plurality of piezoelectric assemblies whose respective piezoelectric bars are coupled to said sensor such that the piezoelectric bars expand simultaneously or contract simultaneously.

Advantageously, the sensor comprises a plurality of sensors connected in series and/or in parallel.

The proposed solution makes it possible to produce a high-capacitance transducer, while at the same time retaining high electro-optical sensitivity and ease of manufacturing of the measurement device.

Other features and advantages of the invention will become apparent on reading the following detailed description, given by way of nonlimiting example and with reference to the appended drawings, in which:

FIG. 1, already described, shows a hybrid hydrophone comprising an electro-optical transducer according to the prior art,

FIG. 2, already described, schematically shows a measurement device comprising a linear acoustic antenna,

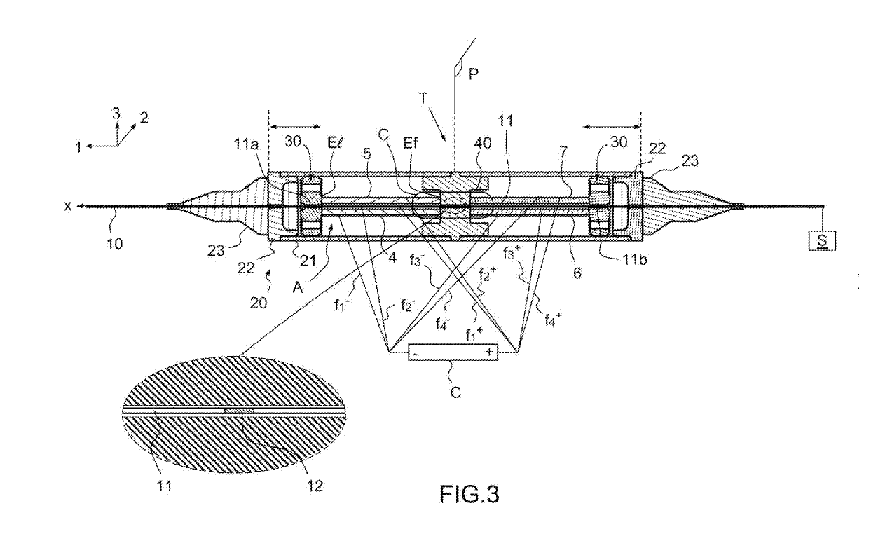

FIG. 3 schematically shows the measurement device according to the invention,

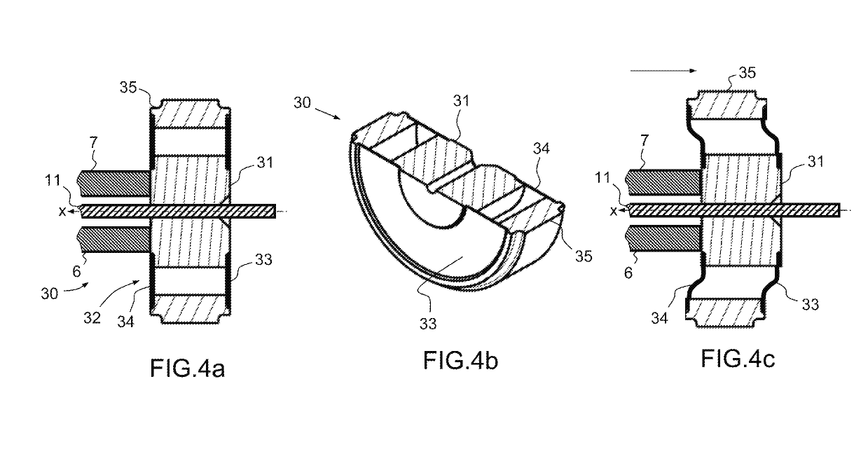

FIG. 4a schematically shows, in cross section, a coupling device according to the invention at rest, FIG. 4b schematically shows, in perspective, a coupling device according to the invention, and FIG. 4c schematically shows the coupling device of FIG. 4a after expansion of piezoelectric bars,

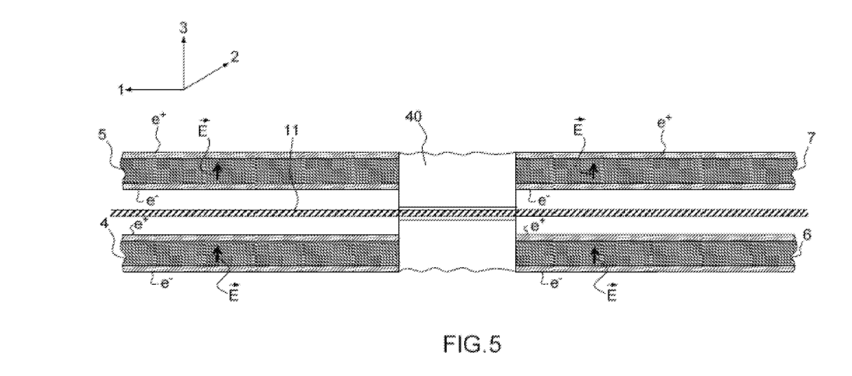

FIG. 5 schematically shows a detail of a portion of FIG. 3 surrounded by an unbroken line C.

From one figure to another, the same elements bear the same references.

The invention relates to an electro-optical transducer intended to convert an electrical signal, generated at the output of a sensor with an electrical output in response to a physical quantity, into an optical signal conveyed in an optical fiber, representative of the electrical signal and therefore of the measured physical quantity. ‘Sensor with an electrical output’ is understood to mean a sensor for measuring a physical quantity and delivering an electrical signal representative of the measured physical quantity.

The electro-optical transducer comprises a piezoelectric actuator, comprising at least one piezoelectric bar made from piezoelectric material, for converting an electrical signal into an optical signal conveyed by an optical fiber, by acting on the elongation of a sensitive area of the optical fiber so as to thereby vary a characteristic of an optical signal conveyed by the optical fiber. The optical signal has a characteristic representative of the electrical signal, which signal is itself representative of the measured physical quantity.

The invention also relates to a measurement device for measuring a physical quantity, comprising a sensor for measuring the physical quantity and delivering an electrical signal representative of the measured physical quantity, and an electro-optical transducer according to the invention subjected to said electrical signal such that the transducer converts the electrical signal into an optical signal, conveyed by the optical fiber, representative of said electrical signal.

This invention relates most particularly to hybrid hydrophones of the type comprising a sensor comprising at least one sensor for converting an acoustic pressure into an electrical signal.

Of course, the invention is not limited to hydrophones. It relates to any measurement device comprising a physical quantity sensor for delivering an electrical signal representative of a physical quantity. The sensor may for example be, non-exhaustively, a heading sensor, a pressure sensor, an acceleration sensor, an immersion sensor, a temperature sensor or a radiofrequency antenna. The output of this sensor may be analog or digital.

The sensor may comprise a single sensor or a plurality of sensors arranged in series and/or in parallel, or a series/parallel combination.

The assembly of at least one sensor delivers a first electrical signal. The assembly of at least one sensor may be linked directly to the electro-optical transducer, and the first electrical signal is then the electrical signal delivered by the sensor. The sensor may comprise a filter interposed between the assembly of at least one sensor and the electro-optical transducer. The electrical signal delivered by the sensor is then an electrical signal obtained by filtering the first electrical signal. The electro-optical transducer is naturally high-pass, and therefore a filter is not essential for filtering the content.

The electrical signal is a voltage representative of the physical quantity. The electrical signal makes it possible to supply the piezoelectric bar(s) with electric power, that is to say to apply an electrical field to the piezoelectric bar(s) between the electrodes.

FIG. 3 schematically shows a measurement device according to the invention. This measurement device comprises a sensor C as defined above and an electro-optical transducer T according to the invention comprising an optical fiber 10. The electro-optical transducer T is coupled electrically to the sensor C so as to convert an electrical signal delivered by the sensor C and applied to the electro-optical transducer T into an optical signal, conveyed by an optical fiber 10, representative of the electrical signal. More precisely, the electro-optical transducer converts, through a piezoelectric effect, a variation in an electrical signal delivered by the sensor into a variation in an elongation of a sensitive area 12 of the optical fiber. The optical fiber 10 conveys an optical signal having a characteristic representative of an elongation of the sensitive area 12 in the direction of the length of the optical fiber 10. The variation in elongation of the sensitive area 12 is therefore reflected in a variation in the characteristic of the optical signal conveyed by the fiber. The characteristic of the optical signal is representative of the elongation of the sensitive area 12 of the optical fiber 10, which is itself representative of the electrical signal representative of the physical quantity.

The characteristic of the optical signal, which varies with the elongation of the sensitive area, is for example a wavelength or a phase of a signal.

The sensitive area 12 is for example of fiber laser type. Fiber lasers comprise a distributed Bragg reflector formed in the sensitive area 12 of the optical fiber 10. The fiber laser emits an optical signal having a wavelength representative of the elongation of the sensitive area 12 in the direction of the length of the optical fiber 10. As a variant, the transducer is configured so as to convert a variation in an electrical signal into a variation in an elongation of the sensitive area of an optical fiber reflected in a variation in the phase of the first optical signal. In this case, there is no distributed Bragg reflector formed in the optical fiber.

The electro-optical transducer comprises a piezoelectric actuator A. The piezoelectric actuator A makes it possible to convert, through a piezoelectric effect, an electrical signal delivered by the sensor C into an elongation of the sensitive area 12 representative of the electrical signal.

To this end, the piezoelectric actuator A comprises a plurality of piezoelectric assemblies each comprising a piezoelectric bar 4, 5, 6, 7 made from piezoelectric material, electrodes and associated electrical wires. In the embodiment of the figures, the actuator A comprises four piezoelectric bars. This embodiment is non-limiting, and the actuator may, as a variant, comprise a piezoelectric bar or a plurality of piezoelectric bars in a number other than four.

Each piezoelectric assembly comprises a pair of electrical wires f1⁺, f1⁻, f2⁺, f2⁻, f3⁺, f3⁻, f4⁺, f4⁻ for electrically coupling one of the piezoelectric bars 4, 5, 6, 7 to the sensor C so as to supply the piezoelectric bar 4, 5, 6, 7 with electric power by way of the electrical signal delivered by the sensor C. To this end, as shown in FIG. 5, the piezoelectric bars are provided, on their surfaces, with conductive electrodes e+, e− forming part of the piezoelectric assembly under consideration. These electrodes fitted to the respective bars are linked to the respective pairs of electrical wires. The direction of the electrical field E to which the various piezoelectric bars are subjected is shown by arrows in FIG. 5. For greater clarity, the electrodes are not shown in FIGS. 3 and 4.

As is able to be seen in the magnification of FIG. 3, the piezoelectric bars 4, 5, 6, 7 are coupled to a section of optical fiber 11 comprising the sensitive area 12. The section of optical fiber 11 is taut and extends longitudinally at rest along a longitudinal axis x. The section of optical fiber 11 is pre-stressed so as to remain taut regardless of the movements of the transducer and the value of the electrical signal generated by the sensor under the effect of the physical quantity in the operating area of the sensor.

At rest, the piezoelectric bars 4, 5, 6, 7 extend longitudinally in respective directions that are substantially parallel to the longitudinal axis x. In the present patent application, it is understood that the piezoelectric bars and the section of optical fiber are at rest when the bars are not supplied with electric power and when the transducer is not subjected to any acceleration. ‘Substantially parallel’ is understood to mean that the longitudinal axes of the bars have small maximum inclines that may result from manufacturing tolerances. This allows better interaction between the bars and makes it possible to limit the sensitivity of the transducer to transverse accelerations.

Each piezoelectric bar 4, 5, 6, 7 is arranged so as to be intended to deform in response to a variation in the electrical signal, that is to say in response to a variation in the electrical field to which it is subjected, essentially by expanding or contracting in the direction of its length parallel to the longitudinal axis. In other words, the bars operate essentially through tension-compression parallel to the axis x. It is the whole bar that contracts or that expands parallel to the longitudinal axis x. This is achieved by the mechanical coupling of each piezoelectric bar with respect to a rigid housing 20 enclosing the actuator A and the section 11 of optical fiber to which it is coupled. This coupling allows a translation of the two longitudinal ends of the bar with respect to one another along the axis x of the housing 20. For each bar, the longitudinal faces of the bar (faces parallel to the axis x) that are parallel to one another are intended to deform in the same way under the effect of a variation in the electrical field E. Each bar 4, 5, 6, 7 is coupled mechanically to the section of optical fiber 11 such that the expansion and the contraction of the electrical bar 4, 5, 6, 7 parallel to the axis x bring about variations in elongation of the section 11 and therefore variations in elongation of the sensitive area 12. More precisely, the expansion and the contraction of the electrical bar 4, 5, 6, 7 parallel to the longitudinal axis x each bring about a deformation of the section 11 essentially along the axis x, and more precisely a variation in elongation of this section along the axis x.

The deformation of the bar essentially through expansion or contraction in the direction of its length parallel to the axis of the fiber at rest makes it possible to achieve better efficiency in elongation mode of the fiber with respect to the electric power applied to the bar than with a piezoelectric bar operating in flexion mode (that is to say a bar operating in bender mode). This type of coupling also allows geometries that are symmetrical about the axis of the fiber, and hence lower sensitivity to parasitic accelerations. The piezoelectric bars 4, 5, 6, 7 are parallelepipedal. Advantageously, the bars are rectangular parallelepipeds. These bars have a length Lp (direction of the bars along the axis x) and a thickness h (distance between the electrodes).

In the electro-optical transducer T according to the invention, each piezoelectric bar 4, 5, 6, 7 is formed of a single crystal. The use of single crystals makes it possible to achieve significant elongation for a given electrical field, thereby making it possible to obtain a transducer having good sensitivity. PZN-PT or PMN-PT come into question, for example. Moreover, the bars 4, 5, 6, 7 are intended to vibrate in transverse mode, also called mode 31 or 32. In other words, the electromechanical coupling of the piezoelectric bar is transverse. This means that the electrical wires f1⁺, f1⁻, f2⁺, f2⁻, f3⁺, f3⁻, f4⁺, f4⁻ are connected to the piezoelectric bars in such a way as to supply the material of the piezoelectric bar with electric power, that is to say to subject the piezoelectric bar to an electrical field, along an axis perpendicular or substantially perpendicular to its main axis of deformation. The main axis of deformation is the axis along which the bars mainly deform under the effect of the electrical field applied by way of the electrical wires. The main axis of deformation is parallel or substantially parallel to the axis x. In the example shown in FIG. 3, the main axis of deformation is the axis 1 in an orthogonal trihedron 1, 2, 3 linked to the bar and conventionally used for piezoelectric materials. The bars operate in mode 31.

Each piezoelectric bar comprises a first electrode e+ and a second electrode e− that are positioned on respective faces of the piezoelectric bar. These faces are defined by the main axis of deformation of the bars and by an axis perpendicular to the axis of application of the electrical field E. In the embodiment of FIG. 3, the electrodes extend in the plane 1, 2.

Modes 31 and 32 have the same figure of merit as mode 33 (longitudinal mode), but have the advantage of making it possible to obtain an electro-optical transducer having a capacitance much greater than that of a transducer according to the prior art, while at the same time retaining high electro-optical sensitivity and ease of manufacturing.

Specifically, the electro-optical capacitance C_{A} of the transducer, expressed in farads, according to the invention as a low-frequency approximation is given by the following formula:

$${C}_{A} = 2 \frac{{L}_{P} b}{h} {ɛ}_{33}^{T} \qquad [ 2 ]$$

where Lₚ is the length of the piezoelectric bar along the axis 1 for mode 31 and along the axis 2 for mode 32, h is the thickness of the piezoelectric bars along the axis 3, that is to say the distance between electrodes, and b is the width of the bars along the axis 2 (mode 31) or along the axis 1 (mode 32).

The capacitance C_{A} of the transducer according to the invention is far higher than the capacitance C_{aa′} that a transducer of the type of FIG. 1 would have, which transducer would have bars of the same dimensions with a single section (n=1) of length Lₚ and the same dielectric coefficient. Specifically, in accordance with formula 1, this capacitance would be given by the following formula:

$${C}_{{aa}^{′}} = 2 {n}^{2} \frac{b * h}{{L}_{p}} {ɛ}_{33}^{T} \qquad [ 3 ]$$

Therefore, in accordance with formulae [2] and [3]: C_{A}/C_{aa′}=L_{P}²/h²>>1

Specifically, the thickness h is much smaller than the length Lₚ.

The capacitance of the transducer according to the invention is therefore very high for a smaller number of connections of electrical wires. Therefore, the transducer according to the invention has good electro-optical sensitivity and is easy to manufacture. Moreover, the capacitance of the transducer is able to be adjusted easily by adjusting the length of the piezoelectric bars.

Typically, the transducer according to the invention may have a capacitance greater than 1 nF and a sensitivity greater than 160 dB Hz/V. A hybrid hydrophone incorporating a transducer according to the invention therefore makes it possible to read very small variations in acoustic pressure.

The electro-optical sensitivity Su of the transducer according to the invention, expressed in dB, is given by the following formula obtained by analytical modeling:

$$Su = 20 log [ 0.78 {f}_{L} \frac{{d}_{31} {L}_{P}}{{hL}_{F}} ]$$

where f_{L}, is the frequency of the laser, d₃₁ is the piezoelectric coefficient and L_{F} is the stretched fiber length.

As is able to be seen in FIG. 3, the transducer T according to the invention comprises a housing 20 enclosing the piezoelectric actuator and the section of optical fiber 11 on which the actuator acts. This makes it possible to protect the piezoelectric actuator. Advantageously, the housing is rigid, thereby making it possible to make the transducer insensitive to the pressure exerted by a liquid in which the housing is immersed, and to achieve good immersion resistance. ‘Rigid’ is understood to mean that the housing is non-deformable over the entire range of pressures in which the transducer is used. The rigid housing is fixed to the optical fiber on either side of the section 11 of optical fiber. The housing is hermetically sealed.

The housing 20 comprises a rigid central part in the form of a rigid tube 21, end parts comprising rigid stops 22 and holding parts 23 bearing on the tube 21 and attached to the ends of the section 11. The stops and the tube, as a variant, could form a single part. The section of optical fiber 11 to which the actuator is coupled is enclosed inside the housing 20. The tube 21 is advantageously rotationally symmetrical about the axis x.

In the embodiment of the figures, the piezoelectric actuator comprises four piezoelectric bars: a first 4, a second 5, a third 6 and a fourth 7 piezoelectric bar.

The piezoelectric actuator comprises coupling devices 30 for mechanically coupling the piezoelectric bars to the section of optical fiber 11 such that the deformation of the bars under the effect of a variation in the electrical signal brings about a variation in elongation of the optical fiber.

Each piezoelectric bar 4, 5, 6, 7 extends longitudinally from a first end to a second end. The first end, called mobile end E1, is intended to move essentially parallel to the axis x with respect to the housing 20 under the effect of a variation in the electrical signal, that is to say under the effect of a deformation of the piezoelectric bar along the axis x. Each mobile end E1 is attached to a portion 11a, 11b of the section of optical fiber 11. The second end, called fixed end Ef, is fixed with respect to the housing 20. For greater clarity, the ends E1 and Ef are referenced only for the second bar 5 in FIG. 3. When the piezoelectric bars 4, 5, 6, 7 expand or contract, the fixed ends Ef remain fixed with respect to the housing 20 and the mobile ends E1 move with respect to the respective fixed ends Ef in the direction of the length of the piezoelectric bars 4, 5, 6, 7, that is to say along the length of the bars, that is to say substantially parallel to the direction x.

In the embodiment of FIG. 3, the various piezoelectric assemblies of the piezoelectric actuator A are arranged so as to form two groups of longitudinal piezoelectric assemblies. A first longitudinal group comprises the piezoelectric bars 4 and 6. These bars 4 and 6 are aligned along an axis substantially parallel to the axis of the section 11, that is to say to the longitudinal axis x. The second longitudinal group comprises the two piezoelectric bars 5 and 7. These bars 5 and 7 are aligned along another axis substantially parallel to the axis x. Therefore, each longitudinal group is a longitudinal pair, and the two bars of each of the longitudinal pairs are positioned side by side along an axis substantially parallel to the axis x and extend longitudinally substantially parallel to one and the same axis x. The mobile ends E1 of the two bars 4 and 6 or 5 and 7 of each of the longitudinal groups move in opposite directions under the effect of an expansion of the bars or under the effect of a contraction of the bars parallel to the longitudinal direction x. The portions 11a, 11b of the section of fiber 11 that are attached to the mobile ends E1 of the piezoelectric bars of each of the longitudinal groups surround the sensitive area 12. As a variant, the device according to the invention comprises a single longitudinal group or more than two longitudinal groups.

Advantageously, all of the piezoelectric bars are arranged and supplied with electric power by way of the electrical signal so as to generate either the expansion of all of the piezoelectric bars simultaneously or the contraction of all of the piezoelectric bars simultaneously. The piezoelectric bars are advantageously supplied with power in parallel.

In the embodiment of FIG. 3, the two fixed ends Ef of two bars 4 and 6 or 5 and 7, aligned in a direction substantially parallel to the axis x, are situated facing one another. In other words, the two fixed ends Ef of the two bars are the adjacent ends of the two bars. The distance between the fixed ends of the two bars is less than the distance between the mobile ends E1 of the two bars.

Therefore, when the bars 4, 5, 6, 7 expand under the effect of a variation in the electrical signal, the elongation of the sensitive area increases. The elongation of a portion of the optical fiber of long length is thus acted on when the bars expand or retract (contract), thereby making it possible not to disturb the operation of the laser.

In the example of FIGS. 3 and 5, the fixed ends Ef of the bars 4, 5, 6, 7 are fixed to a holder 40 that is attached to the housing 20 and is interposed between the bars 4, 6 of the first pair of piezoelectric assemblies and between the piezoelectric bars 5, 7 of the second pair of piezoelectric assemblies. As a variant, the fixed ends Ef are attached to the housing 20 or to separate holders. The form of the holder 40 is not limited to that shown in FIG. 3.

As a variant, the mobile ends E1 of the bars aligned along one and the same axis are positioned facing one another. The elongation of a portion of the optical fiber of short length is thus acted on when the bars expand or retract. Advantageously, the piezoelectric actuator A has a first plane P of symmetry perpendicular to the longitudinal axis x. In other words, the piezoelectric bars aligned along one and the same axis are identical, that is to say are made from one and same material, have the same dimensions and the same orientation about the axis along which they are aligned and are coupled to the optical fiber by way of identical coupling devices. This feature makes it possible to limit the sensitivity of the transducer to accelerations in the axial direction (parallel to the axis x). Specifically, the two bars aligned along one and the same axis in the axial direction have one and the same stiffness and deform in a contrasting manner under the effect of an axial acceleration, thereby making it possible to avoid a variation in elongation of the sensitive area 12.

In one variant, the piezoelectric actuator comprises a single piezoelectric bar per axis parallel to the longitudinal axis x. In this case, the piezoelectric bar comprises two ends that are mobile along the axis x, each of which is coupled to the optical fiber by way of a coupling device 30.

Advantageously, as is the case in FIG. 3, the piezoelectric assemblies of the actuator are arranged so as to form at least one group of transverse piezoelectric assemblies of piezoelectric assemblies whose piezoelectric bars 4 and 5 (or 6 and 7, respectively) each comprise an end Ef that is fixed with respect to the housing 20 and a mobile end E1 able to move with respect to the housing 20 under the effect of an expansion or of a contraction of said piezoelectric bar parallel to the axis x, that is to say under the effect of a variation in the electric power supply signal. Each transverse group comprises at least one transverse pair of piezoelectric assemblies of which the piezoelectric bars of each transverse group, that is to say the bars 4 and 5 or the bars 6 and 7, respectively, are situated on either side, respectively, of the longitudinal axis x in a direction perpendicular to the longitudinal axis x. The piezoelectric bars 4 and 5, or 6 and 7, respectively, of each transverse pair are attached to one and the same portion 11a, or 11b, respectively, of the section of optical fiber 11 and move in the same direction under the effect of an expansion of the bars or under the effect of a contraction of said piezoelectric bars substantially parallel to the longitudinal axis, that is to say under the effect of a variation in the electrical signal, by subjecting the bars to electrical fields that induce a simultaneous expansion of all of the bars or a simultaneous contraction of all of the bars.

In the embodiment of FIG. 3, the device comprises two transverse groups. Each of the transverse groups comprises two piezoelectric assemblies, that is to say two piezoelectric bars 4 and 5 and 6 and 7, respectively. The mobile ends of the bars of two different transverse groups move in opposite directions under the effect of an expansion of the bars parallel to the axis x.

Advantageously, the piezoelectric actuator has two other planes of symmetry, which are the planes orthogonal to the plane P of FIG. 3, and which contain the axis x. This feature makes it possible to limit the sensitivity of the transducer to accelerations in the transverse directions 1 and 2.

Each transverse group may comprise more than two piezoelectric assemblies. The piezoelectric bars of a transverse group have for example longitudinal axes that are substantially parallel to the axis and are regularly distributed over a circle perpendicular to the axis x.

FIGS. 4a and 4b schematically show a cross section in the plane of the page of FIG. 3 (FIG. 4a) and a perspective view of the cross section of FIG. 4a (FIG. 4b) of a coupling device 30 for mechanically coupling at least one piezoelectric bar to said optical fiber so as to convert an expansion or contraction of each piezoelectric bar to which it is linked into a variation in elongation of the optical fiber. The coupling device 30 makes it possible to couple the mobile end E1 of at least one bar 4, 5, 6, 7 to the section 11 of the optical fiber 12.

In the embodiment of FIGS. 3 and 4, the actuator comprises two coupling devices 30. The section of optical fiber 11 extends between the two coupling devices 30 and is pre-stressed so as to be kept taut between the two coupling devices 30.

Each coupling device 30 makes it possible to couple the mobile end E1 of two bars 4, 5, or 6, 7 to the section of optical fiber 11.

The coupling device 30 could be glue or any other fixing means.

In the preferred embodiment, the coupling device 30 comprises a carriage 31 able to move in translation with respect to the rigid housing along the axial direction x. The carriage 31 is attached to the optical fiber 11, and more precisely to a portion of the optical fiber 11. As is able to be seen in FIG. 3, each mobile end E1 of a bar 4, 5, 6, 7 is fixed to a carriage 31 of a coupling device 30.

In the embodiment of FIGS. 3 and 4, the ends of two piezoelectric bars 4, 5 or 6, 7 are fixed to each carriage 31.

The coupling device 30 comprises a linking unit 32 for linking the carriage 31 to the rigid housing 20. In the embodiment of FIGS. 3, 4a, 4b and 4c, the linking unit 32 links the carriage 31 to a joining area 35 belonging to the coupling device and that is fixed with respect to the housing 20. As a variant, the linking unit 32 links the carriage 31 directly to the housing 20, and more particularly to the cylindrical tube 21. The joining area 35 then belongs to the housing 20.

Advantageously, the linking unit 32 is designed to permit a translation of the carriage 31 with respect to the housing 20 along the longitudinal axis x, but to prevent any significant movement of the carriage 31 with respect to the housing 20 along the radial directions in relation to the axis x. In other words, the linking unit has an axial stiffness (parallel to the axis x) that is lower than the radial stiffness (perpendicular to the axis x).

When the electrical signal varies, each piezoelectric bar 4, 5, 6, 7 expands or contracts parallel to the axial direction. With its mobile end E1 being fixed to a carriage 31, this deformation of a piezoelectric bar 4, 5, 6, 7 tends to cause the carriage 31 to move parallel to the axial direction x, as shown by the arrows in FIG. 3. Given that the linking unit 32 permits a translation of the carriage 31 with respect to the housing 20, the carriage 31 moves parallel to the axial direction x with respect to the housing 20, taking with it the portion of the optical fiber 11 to which it is fixed, thereby having the effect of varying the elongation of the sensitive area 12 of the optical fiber 11. The low axial stiffness (that is to say in the direction x) of the linking unit 32 makes it possible to limit impairments of the electro-acoustic sensitivity of the transducer.

When the transducer is subjected to transverse acceleration, the piezoelectric bars flex. The high stiffness of the linking unit 32 in a direction perpendicular to the axial direction x makes it possible to prevent the movement of the portion of fiber 11a, 11b to which the coupling device 30 is fixed in a radial plane. The solution that is shown therefore makes it possible to reduce the sensitivity of the transponder to accelerations. Specifically, the lasers with fiber laser cavities used in this solution are extremely sensitive to any deformation. The solution limits the variation in elongation of the fiber that is induced by the accelerations seen by the transponder, while at the same time retaining high electro-optical sensitivity, which is given by a large axial deformation of the fiber per volt of excitation across the terminals of the electro-optical transponder. In other words, the solution that is shown selects the electrically excited deformation mode, while at the same time minimizing the deformation modes induced in directions perpendicular to the axis of the fiber laser. The linking device 32 also makes it possible to reduce the effect of small manufacturing defects, in particular defects of parallelism between the longitudinal axes of the bars and the axis x, by allowing the optical fiber to deform only in the axial direction.

Advantageously, the linking unit 32 is designed to permit a translation of the carriage 31 with respect to the housing 20 parallel to the axis x, while preventing any significant movement of the carriage 31 with respect to the housing 20 along any direction in a plane perpendicular to the longitudinal axis x. To this end, the linking unit is for example rotationally symmetrical about the longitudinal axis x.

To this end, the linking unit comprises at least one flexion part 33, 34 having a high stiffness in a radial direction. This high stiffness does not allow the carriage to move in the radial direction. The linking part 33, 34 is moreover very narrow, in the axial direction, in comparison to its dimension in the radial direction, so as to have a low stiffness in the axial direction. This low stiffness allows the carriage 31 to move with respect to the housing 20 in the axial direction. It makes it possible not to excessively impair the sensitivity of the transducer.

In the embodiment shown in FIGS. 4a, 4b and 4c, the linking unit 32 comprises two flexion strips 33, 34 extending, at rest, in respective planes that are substantially perpendicular to the longitudinal axis x. They link the carriage 31 to the joining area 35 that is attached to the housing. The flexion strips 33, 34 have a high radial stiffness and a low stiffness in the axial direction. This embodiment makes it possible to stop the carriage (and therefore the optical fiber) from rotating about axes perpendicular to the axis x.

Advantageously, the flexion strips 33, 34 are rotationally symmetrical about the axis x.

As a variant, the linking unit 32 comprises a single flexion strip 33. In another variant, the flexion strips are replaced with one or more toroidal gaskets linking the carriage 31 and the joining area 35, or with any other means having a stiffness that is high in the radial direction and low in the radial direction.

In the embodiment of FIGS. 4a, 4b and 4c, the coupling device comprises a cylindrical tubular carriage 31 attached to a portion of the section of the optical fiber 11. The carriage 31 is rotationally symmetrical about the axis x. The carriage 31 is passed through by the optical fiber 10, which extends longitudinally along the axis x. The two flexion strips 33, 34 are flat rings, that is to say disks having a central aperture by way of which the optical fiber passes through the carriage 31. The flexion strips 33, 34 are rotationally symmetrical about the axis x. These strips 33, 34 in the shape of flat rings surround the carriage 31. The strips 33, 34 extend radially from the carriage 31 as far as the joining area 35. They are for example fixed at the respective longitudinal ends of the carriage 31. The longitudinal ends of the carriage 31 are the ends of the carriage 31 parallel to the axis x.

In the embodiment of FIGS. 3, 4a and 4b, the joining area 35 is a tube attached to the housing with rotational symmetry about the axis of the fiber. The joining area 35 surrounds the flexion strips 33, 34 and the optical fiber 10. The joining area 35 has an inner diameter greater than the outer diameter of the carriage 31, such that a space is formed, in the radial direction, between the outer surface of the carriage 31 and the inner surface of the joining area 35. This allows the strips to flexurally deform freely.

When the bars 4, 5, 6, 7 expand or contract, they exert an axial force on the carriage 31 that brings about flexion of the flexible strips 33, 34, thus allowing the translation of the carriage 31 in the axial direction x with respect to the housing, as is shown in FIG. 4c. FIG. 4c shows the form of the coupling device of FIG. 4a after expansion of the bars 6 and 7. The deformation of the assembly formed by the flexible strips 33, 34, the carriage 31 and the joining area 35 is close to that of a deformable double parallelogram.

The position of the two strips 33, 34, respectively on either side of the carriage 31 in the axial direction, or more generally spaced apart in the axial direction, makes the rotational movement of the carriage 31 about the axis x with respect to the housing 20 impossible. Parasitic variations in the optical signal due to radial accelerations are thus avoided.

The flexion strips may be solid or perforated.

In the embodiment shown in FIGS. 3 and 5, the actuator comprises four piezoelectric bars 4, 5, 6, 7 forming two longitudinal pairs of piezoelectric assemblies and two transverse pairs of piezoelectric assemblies. The bars are aligned two by two along respective axes that are substantially parallel to the axis x. Moreover, the actuator has three orthogonal planes of symmetry. This embodiment makes it possible to keep a high degree of symmetry, thereby making it possible to limit the sensitivity of the transducer to accelerations.

Advantageously, the holder 40 and/or the carriage 31 and/or the joining area 35 are made from a material having a coefficient of thermal expansion (less than 10.10⁻⁶/K⁻¹) at 15° C. and at atmospheric pressure. This makes it possible to limit the sensitivity of the device to variations in temperature and thus to increase the number of transducers that are able to be placed in series on one and the same optical fiber.

The holder 40 is advantageously made from Zerodur, the coefficient of thermal expansion of which is very low. As a variant, it could be made from glass. The carriage 31 is advantageously made from Zerodur. As a variant, it could be made from glass. These parts could also be made from titanium, with less effectiveness in limiting the sensitivity of the transducer to variations in temperature.

The strips 33, 34 are for example metal parts, for example made from steel. This material is inexpensive and readily available on the market.

The housing is made for example from titanium or from steel or any other pressure-resistant material.

The transducer according to the invention has a very high dynamic range. It makes it possible to measure voltages ranging from one nanovolt to 10 V.

1. An electro-optical transducer for converting an electrical signal delivered by a physical measurement sensor into an optical signal, said electro-optical transducer comprising:
an optical fiber comprising a section of optical fiber comprising a sensitive area, the optical fiber conveying said optical signal, said optical signal being representative of an elongation of the sensitive area, the section of optical fiber being taut and extending longitudinally at rest substantially along a longitudinal axis,
a piezoelectric actuator comprising at least one piezoelectric assembly comprising a piezoelectric bar, the piezoelectric bar extending longitudinally at rest substantially parallel to the longitudinal axis, said piezoelectric bar being provided with a pair of electrodes between which the piezoelectric bar is intended to be supplied with electric power by way of the electrical signal, said piezoelectric bar being intended to deform essentially through expansion or contraction of said bar parallel to the longitudinal axis in response to a variation in the electrical signal and being coupled mechanically to the section of optical fiber such that this expansion or contraction of the piezoelectric bar brings about a variation in elongation of the sensitive area,
wherein the piezoelectric bar is formed of a single crystal and in that it is intended to vibrate in mode.

2. The electro-optical transducer as claimed in claim 1, comprising a housing enclosing said actuator, said section of optical fiber, the piezoelectric bar comprising a mobile end able to move with respect to the housing upon said expansion or said contraction of the piezoelectric bar substantially parallel to the longitudinal direction.

3. The electro-optical transducer as claimed in claim 1, wherein said piezoelectric actuator comprises a coupling device for mechanically coupling the mobile end to the section of optical fiber, said coupling device comprising a carriage fixed to a portion of the section of optical fiber and being able to move in translation with respect to the housing along the longitudinal axis, said coupling device furthermore comprising a linking unit for linking the carriage to a joining area attached to the housing, the linking unit being designed to permit a translation of the carriage with respect to the housing in the axial direction but to prevent any significant movement of the carriage with respect to the housing in a plane perpendicular to the axial direction.

4. The electro-optical transducer as claimed in claim 2, wherein the piezoelectric bar comprises a fixed end, which is fixed with respect to the housing.

5. The electro-optical transducer as claimed in claim 3, wherein the linking unit comprises at least one flexion strip extending, at rest, in a plane substantially perpendicular to the longitudinal axis and linking the carriage to a joining area attached to the housing.

6. The electro-optical transducer as claimed in claim 1, wherein the strip is rotationally symmetrical about the axis.

7. The electro-optical transducer as claimed in claim 5, comprising two strips extending, at rest, in different respective planes that are substantially perpendicular to the longitudinal axis.

8. The electro-optical transducer as claimed in claim 1, comprising a housing enclosing the piezoelectric actuator and the section of optical fiber, said piezoelectric actuator comprises a plurality of piezoelectric assemblies arranged so as to form at least one pair, called longitudinal pair, of two piezoelectric assemblies whose piezoelectric bars each comprise an end that is fixed with respect to the housing and a mobile end able to move with respect to the housing under the effect of an expansion or of a contraction of said piezoelectric bar, said piezoelectric bars of the two piezoelectric assemblies of the longitudinal pair being aligned along an axis substantially parallel to the longitudinal axis and their mobile ends moving in opposite directions under the effect of an expansion of said bars or under the effect of a contraction of said piezoelectric bars parallel to the longitudinal axis, the portions of the section of fiber that are attached to the mobile ends of said piezoelectric bars surrounding the sensitive area.

9. The electro-optical transducer as claimed in claim 1, wherein the fixed ends of the piezoelectric bars of the two piezoelectric assemblies of the longitudinal pair are positioned facing one another.

10. The electro-optical transducer as claimed in claim 8, wherein the piezoelectric actuator has a first plane of symmetry perpendicular to the axis.

11. The transducer as claimed in claim 1, comprising a housing enclosing the piezoelectric actuator and the section of optical fiber, said piezoelectric actuator comprises a plurality of piezoelectric assemblies arranged so as to form at least one group, called transverse group, of a plurality of piezoelectric assemblies whose piezoelectric bars each comprise an end that is fixed with respect to the housing and a mobile end able to move with respect to the housing under the effect of an expansion or of a contraction of said piezoelectric bar substantially parallel to the longitudinal axis, said piezoelectric bars of the piezoelectric assemblies comprising at least one transverse pair of piezoelectric assemblies whose piezoelectric bars are situated respectively on either side of the longitudinal axis in a direction perpendicular to the longitudinal axis, being attached to one and the same portion of the section of optical fiber and moving in the same direction under the effect of an expansion of said piezoelectric bars or under the effect of a contraction of said piezoelectric bars parallel to the longitudinal axis.

12. The electro-optical transducer as claimed in claim 11, comprising four piezoelectric assemblies forming two longitudinal pairs and two transverse groups, each transverse group each comprising a transverse pair, and further comprising a housing enclosing the piezoelectric actuator and the section of optical fiber, said piezoelectric actuator comprises a plurality of piezoelectric assemblies arranged so as to form at least one pair, called longitudinal pair, of two piezoelectric assemblies whose piezoelectric bars each comprise an end that is fixed with respect to the housing and a mobile end able to move with respect to the housing under the effect of an expansion or of a contraction of said piezoelectric bar, said piezoelectric bars of the two piezoelectric assemblies of the longitudinal pair being aligned along an axis substantially parallel to the longitudinal axis and their mobile ends moving in opposite directions under the effect of an expansion of said bars or under the effect of a contraction of said piezoelectric bars parallel to the longitudinal axis, the portions of the section of fiber that are attached to the mobile ends of said piezoelectric bars surrounding the sensitive area.

13. The electro-optical transducer as claimed in claim 1, wherein the piezoelectric actuator has two planes of symmetry that are perpendicular to one another and contain the axis.

14. The electro-optical transducer as claimed in claim 3, wherein the carriage and/or the joining area and/or the housing are made from a material having a coefficient of thermal expansion of less than 10.10⁻⁶/K⁻¹ at 15° C. and at atmospheric pressure.

15. A device for measuring a physical quantity comprising an electro-acoustic transducer as claimed in claim 1, a sensor able to deliver the electrical signal, the electrical signal being representative of a physical quantity measured by said sensor, said sensor being coupled electrically to said bar so as to supply said piezoelectric bar with electric power by way of the electrical signal.

16. The device for measuring a physical quantity as claimed in claim 1, comprising a plurality of piezoelectric assemblies whose respective piezoelectric bars are coupled to said sensor such that the piezoelectric bars expand simultaneously or contract simultaneously.

17. The measurement device as claimed in claim 15, wherein the sensor comprises a plurality of sensors connected in series and/or in parallel.
